(19) United States
(12) Patent Application Publication
(10) Pub. No.: US 2025/0084235 A1
(43) Pub. Date: Mar. 13, 2025

(54) Low Emission Polyoxymethylene Composition

(71) Applicant: Celanese International Corporation, Irving, TX (US)

(72) Inventors: Klaus Kurz, Kelsterbach (DE); Christian Ohm, Gernsheim (DE)

(21) Appl. No.: 18/812,357

(22) Filed: Aug. 22, 2024

Related U.S. Application Data
(60) Provisional application No. 63/581,369, filed on Sep. 8, 2023.

(51) Int. Cl. C08K 5/3445; C08K 5/00; C08K 5/13; C08K 5/25; C08K 7/14; C08L 59/04

(52) U.S. Cl. CPC C08K 5/3445; C08K 5/005; C08K 5/13; C08K 5/25; C08K 7/14; C08L 59/04; C08K 2201/019

(57) ABSTRACT

A polyoxymethylene polymer composition is disclosed containing a formaldehyde stabilizer package. The formaldehyde stabilizer package contains, in one embodiment, a substituted hydantoin that has been found to dramatically reduce formaldehyde emissions either alone or in combination with another emission control agent. Lower formaldehyde emissions were also found to occur when the polymer composition did not contain a calcium stearate.

### RELATED APPLICATIONS

The present application is based upon and claims priority to U.S. Provisional Application Ser. No. 63/581,369 having a filing date of Sep. 8, 2023, which is incorporated herein by reference.

### BACKGROUND

Polyacetal polymers, which are commonly referred to as polyoxymethylenes, have become established as exceptionally useful engineering materials in a variety of applications. Polyoxymethylene polymers, for instance, are widely used in constructing molded parts, such as parts for use in the automotive industry and the electrical industry. Polyoxymethylene polymers, for instance, have excellent mechanical properties, fatigue resistance, abrasion resistance, chemical resistance, and moldability.

Although polyacetal resins possess many useful properties, the polymers have a tendency to degrade when heated and are inherently unstable in an oxidative atmosphere or in an acidic or alkaline environment. In particular, polyacetal resins have a tendency to emit formaldehyde during processing and after the polymer has been molded into a part. Formaldehyde is not only a contaminant, but can also adversely affect metallic components that may be placed in association with the polymer. For example, formaldehyde readily oxidizes to formic acid which can corrode metals or cause discoloration.

In view of the above, those skilled in the art have attempted to combine polyacetal polymers with various compounds in order to lower formaldehyde emissions. For instance, in the past, polyacetal polymers have been combined with melamines in order to achieve lower formaldehyde emission performance. In addition, various other chemical compounds have been suggested for lowering formaldehyde emissions.

Although various chemical compounds used in the past have successfully lowered formaldehyde emissions from products made from polyoxymethylene polymers, further improvements in formaldehyde emissions are needed. For instance, stricter government regulations continue to require further improvements in reducing formaldehyde emissions.

In view of the above, a need exists for an improved formaldehyde stabilizer package capable of further reducing formaldehyde emissions.

### SUMMARY

In general, the present disclosure is directed to a polymer composition containing primarily a polyacetal resin and to molded products made from the composition. The polymer composition of the present disclosure is particularly formulated to exhibit ultra-low formaldehyde emissions. For example, polyoxymethylene polymer compositions formulated in accordance with the present disclosure can exhibit a formaldehyde emission when tested according to VDA Test 275 of less than about 2 ppm, such as less than about 1 ppm. The VDA 275 Test (German Automotive Industry Recommendation No. 275) is documented by Kraftfahrwesen e. V., July 1994. Unless otherwise indicated, the test is conducted on a plaque (40 mm×100 mm) having a thickness of 1 mm and formaldehyde emission is tested 24 hours after extraction.

In one embodiment, for instance, the polymer composition of the present disclosure comprises a polyoxymethylene polymer in combination with a formaldehyde stabilizer package for reducing formaldehyde emissions. The formaldehyde stabilizer package, in one embodiment, can comprise at least one emission control agent. In particular, it was discovered that a particular substituted hydantoin is very effective at reducing formaldehyde emissions. The substituted hydantoin can be used in combination with other hydrazides and/or other emission control agents. Molded articles made according to the present disclosure can also exhibit very stable color qualities, making the polymer composition well suited for producing interior automotive trim pieces and the like.

In one embodiment, for instance, the present disclosure is directed to a polyoxymethylene polymer in combination with a formaldehyde stabilizer package that comprises a substituted hydantoin in combination with one or more aliphatic carboxylic hydrazides. The weight ratio between the aliphatic carboxylic hydrazide and the substituted hydantoin can be from about 1:20 to about 10:1, such as from about 1:8 to about 2:1, such as from about 1:4 to about 1.25:1.

The substituted hydantoin can be present in the polymer composition in an amount less than about 3% by weight, such as in an amount less than about 2% by weight, such as in an amount less than about 1% by weight, such as in an amount less than about 0.8% by weight, such as in an amount less than about 0.5% by weight, and generally in an amount greater than about 0.01% by weight, such as in an amount greater than about 0.03% by weight, such as in an amount greater than about 0.05% by weight, such as in an amount greater than about 0.09% by weight, such as in an amount greater than about 0.1% by weight, such as in an amount greater than about 0.12% by weight, such as in an amount greater than about 0.15% by weight, such as in an amount greater than about 0.17% by weight, such as in an amount greater than about 0.2% by weight. The substituted hydantoin can contain two hydrazino carbonyl alkyl groups. The substituted hydantoin can have a melting point of less than about 150° C., such as less than about 140° C., such as less than about 130° C., such as less than about 125° C., and generally greater than about 100° C. The substituted hydantoin can have a relatively low cure temperature of less than about 125° C., such as less than about 120° C., such as less than about 115° C., and generally greater than about 100° C., such as greater than about 105° C. In one particular embodiment, the substituted hydantoin comprises 4-isopropyl-2,5-dioxoimidazolidine-1,3-di (propionohydrazide).

As described above, the substituted hydantoin can be combined with an aliphatic carboxylic hydrazide. The aliphatic carboxylic hydrazide can be a dihydrazide. Examples of dihydrazides include sebacic acid dihydrazide, dodecanedioic acid dihydrazide, or mixtures thereof. In one aspect, one or more aliphatic carboxylic hydrazides can be present in the polymer composition in an amount greater than about 0.01% by weight, such as in an amount greater than about 0.02% by weight, such as in an amount greater than about 0.03% by weight, such as in an amount greater than about 0.04% by weight, and in an amount less than about 3% by weight, such as in an amount less than about 2% by weight, such as in an amount less than about 1% by weight, such as in an amount less than about 0.6% by weight, such as in an amount less than about 0.4% by weight, such as in an amount less than about 0.1% by weight.

Other optional components that can be contained in the polymer composition include a nucleant in an amount from about 0.05% to about 1% by weight, a phenolic antioxidant in an amount from about 0.05% to about 2% by weight, and a lubricant in an amount from about 0.05% to about 1.5% by weight. The nucleant, for instance, can comprise a polyoxymethylene terpolymer. The polymer composition can also optionally contain a thermoplastic elastomer, reinforcing fibers, and/or a UV stabilizer.

The formaldehyde emission properties of molded articles made from the polymer composition is somewhat dependent upon the temperature at which the article is molded. The formaldehyde stabilizer package of the present disclosure has been found to perform well at all molding temperatures, which is unexpected in view of formaldehyde stabilizer packages used in the past. For example, the polymer composition can display a formaldehyde emission according to Test VDA-275 at a thickness of 1 mm and at a molding temperature of 205° C. and after drying for 2 hr. at 140° C. of less than about 20 ppm, such as less than about 15 ppm, such as less than about 10 ppm, such as less than about 5 ppm. At a molding temperature of 195° C., the polymer composition can display a formaldehyde emission of less than about 15 ppm, such as less than about 10 ppm, such as less than about 3 ppm. At a molding temperature of 185° C., the polymer composition can display a formaldehyde emission of less than about 8 ppm, such as less than about 5 ppm, such as less than about 3 ppm such as less than about 2 ppm, such as less than about 1 ppm.

The polymer composition can also be tested for formaldehyde emission according to a 10-Liter Bag Test. Polymer compositions made according to the present disclosure, for instance, when tested according to the 10-Liter Bag Test at a molding temperature of 195° C. and after drying for 2 hr. at 140° C. can display a formaldehyde emission of less than about 300 μg/m³, such as less than about 250 μg/m³, such as less than about 200 μg/m³, such as less than about 150 μg/m³. At a molding temperature of 205° C., the polymer composition can display a formaldehyde emission of less than about 10,000 μg/m³, such as less than about 5,000 μg/m³, such as less than about 1,000 μg/m³, such as less than about 750 μg/m³. The test plaque(s) can have a thickness of 1 mm and a mass of 26 g. For instance, a single plaque can be tested having dimensions of 100 mm×200 mm or multiple plaques can be tested together having the same surface area (e.g. 2 plaques having dimensions of 100 mm×100 mm or 5 plaques having dimensions of 40 mm×100 mm), wherein the mass is constant at 26 g.

It was discovered that lower formaldehyde emission levels can be obtained when the polymer composition does not contain any alkaline earth metal salts of an aliphatic carboxylic acid such as taught in U.S. Pat. No. 11,555,111, which is incorporated herein by reference. For instance, the polymer composition can be free of calcium stearate and/or calcium 12-hydroxystearate. In view of the '111 patent, formaldehyde emission levels achieved with the polymer composition of the present disclosure are surprising and unexpected.

All different types of molded articles can be made according to the present disclosure from the polymer composition containing the formaldehyde stabilizer package. For instance, the molded article can comprise an interior automotive part. The molded article can comprise a latch, a lever, a gear, a pivot housing, a speaker grill, a door handle, a decorative trim piece, a bracket, a seat rail, or the like. Medical products can also be made from the polymer composition, such as components of an inhaler or an injector.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of the interior of an automobile illustrating various molded articles that may be made in accordance with the present disclosure;

FIG. 2 is a perspective view of a medical inhaler that may be made from molded parts in accordance with the present disclosure; and

FIG. 3 is a perspective view of a medical injector containing molded parts made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer composition containing a polyacetal resin, particularly a polyoxymethylene copolymer, that exhibits low formaldehyde emissions. The polymer composition is well suited for use in molding processes for producing molded articles. The polymer composition can contain one or more coloring agents for producing molded articles having any desired color. The molded articles can be used in a limitless variety of different applications and in multiple fields. In one embodiment, for instance, molded articles may be made according to the present disclosure that are designed to function as automotive parts, such as automotive parts designed to be used in the interior of vehicles, such as cars and trucks.

More particularly, the present disclosure is directed to a polymer composition containing a polyacetal resin in combination with a formaldehyde stabilizer package. The formaldehyde stabilizer package comprises at least one emission control agent. In particular, it was found that a substituted hydantoin having particular properties was found to be a very effective emission control agent optionally in combination with other hydrazides. In addition, it was discovered that formaldehyde emissions are dramatically and surprisingly lower when the polymer composition is formulated so as not to contain various alkaline earth metal salts of aliphatic carboxylic acids. For instance, formaldehyde emissions were found to be dramatically lower when the composition did not contain a calcium salt of a carboxylic acid, such as a calcium stearate, including calcium 12-hydroxystearate. Optionally, the polymer composition can be formulated so as not to contain any metal salts of organic acids, such as a calcium citrate, including tricalcium citrate.

In one aspect, the substituted hydantoin contains two hydrazino carbonyl alkyl groups. The particular substituted hydantoin for incorporation into the polymer composition, in one aspect, can have a relatively low melting point and a relatively low curing temperature. For instance, the melting point of the substituted hydantoin can be less than about 150° C., such as less than about 140° C., such as less than about 130° C., such as less than about 125° C., such as less than about 122° C. The melting point can be greater than about 100° C., such as greater than about 110° C., such as greater than about 115° C., such as greater than about 118° C. The substituted hydantoin can be configured to cure at a temperature of less than about 125° C., such as less than about 120° C., such as less than about 115° C., such as less than about 112° C., and generally greater than about 100° C., such as greater than about 105° C. (after a one hour exposure to the above temperatures).

In one particular embodiment, the substituted hydantoin can comprise 4-isopropyl-2,5-dioxoimidazolidine-1,3-di (propionohydrazide).

In the past, a hydantoin compound having two hydrazino carbonyl alkyl groups has been suggested for use in polyacetal resin compositions for lowering the generation of formaldehyde from a molded article. For instance, U.S. Pat. No. 11,555,111 is directed to a polyacetal resin composition and is incorporated herein by reference. In stark contrast to polymer compositions made according to the present disclosure, however, the '111 patent discloses polyacetal resin compositions that must contain an alkaline earth metal salt of an aliphatic carboxylic acid, such as calcium stearate or calcium 12-hydroxystearate. It was discovered, however, that formaldehyde emissions can actually be reduced by formulating the composition so as not to contain calcium stearate, calcium 12-hydroxystearate, or other alkaline earth metal salts of aliphatic carboxylic acids. This result is unexpected in view of the '111 patent.

In one embodiment, the formaldehyde stabilizer package of the present disclosure can contain the substituted hydantoin emission control agent in combination with one or more aliphatic carboxylic hydrazides. The substituted hydantoin emission control agent, for instance, can contain two hydrazino carbonyl alkyl groups. In one aspect, the substituted hydantoin comprises 4-isopropyl-2,5-dioxoimidazolidine-1,3-di (propionohydrazide). The aliphatic carboxylic hydrazide can be a dihydrazide. Particular examples of dihydrazides include, for instance, sebacic acid dihydrazide, dodecanedioic acid dihydrazide, or mixtures thereof.

In one aspect, one or more aliphatic carboxylic hydrazides can be present in relation to the substituted hydantoin at a weight ratio of from about 1:20 to about 10:1, such from about 1:8 to about 2:1, such as from about 1:4 to about 1.25:1. Although the weight ratios can vary depending upon the particular application, the above weight ratios have been found to be particularly effective at reducing formaldehyde emissions, making the molded articles particularly well suited for producing trim pieces for the interior of vehicles, such as automobiles, or for producing consumer appliance parts.

One or more aliphatic carboxylic hydrazides can be present in the polymer composition generally in an amount from about 0.001% by weight to about 3% by weight, including all increments of 0.1% by weight therebetween. In one aspect, one or more aliphatic carboxylic hydrazides are present in the polymer composition in lesser amounts, such as in an amount less than about 0.2% by weight, such as in an amount less than about 0.15% by weight, such as in an amount less than about 0.12% by weight, such as in an amount less than about 0.1% by weight, such as in an amount less than about 0.09% by weight, such as in an amount less than about 0.08% by weight. Minimizing the amount of aliphatic carboxylic hydrazides present in the composition can offer various advantages and benefits including minimizing free hydrazide in the composition and providing color stability.

The amount of the substituted hydantoin present in the polymer composition can vary depending upon whether the substituted hydantoin is present alone in the composition or in combination with other emission control agents. In general, the substituted hydantoin can be present in the polymer composition in an amount from about 0.0001% by weight to about 4% by weight, including all increments of 0.01% by weight therebetween. In one embodiment, the substituted hydantoin is present in the polymer composition in amounts greater than any other emission control agents present in the composition. In various embodiments, the substituted hydantoin can be present in the polymer composition in an amount greater than 0.03% by weight, such as in an amount greater than about 0.04% by weight, such as in an amount greater than about 0.1% by weight, such as in an amount greater than about 0.12% by weight, such as in an amount greater than about 0.15% by weight, such as in an amount greater than about 0.17% by weight, such as in an amount greater than about 0.2% by weight, such as in an amount greater than about 0.22% by weight, such as in an amount greater than about 0.24% by weight. The substituted hydantoin can be present in the polymer composition, in various embodiments, in an amount less than about 0.8% by weight, such as in an amount less than about 0.6% by weight, such as in an amount less than about 0.55% by weight, such as in an amount less than about 0.5% by weight, such as in an amount less than about 0.45% by weight, such as in an amount less than about 0.4% by weight, such as in an amount less than about 0.35% by weight, such as in an amount less than about 0.3% by weight.

In one embodiment, the formaldehyde stabilizer package includes the emission control agents described above while excluding other formaldehyde scavengers used in the past. For instance, the polymer composition can be formulated to be melamine-free. In fact, the polymer composition can be formulated so as to not contain any melamines or any melamine derivatives. In one aspect, the polymer composition does not contain any guanamine compounds.

Other emission control agents that can be present in the formaldehyde stabilizer package include an amino acid, such as arginine, or an alkylene urea, such as ethylene urea. Additional emission control agents can be present in the polymer composition generally in an amount from about 0.01% by weight to about 0.5% by weight, including all increments of 0.01% by weight therebetween.

When combined with a polyoxymethylene polymer, the formaldehyde stabilizer package of the present disclosure as described above can produce polymer compositions and molded articles with not only low formaldehyde emission properties, but also excellent mechanical properties and visual appeal.

For instance, in one embodiment, the polymer composition containing the polyoxymethylene polymer exhibits a formaldehyde emission pursuant to VDA 275 of less than about 3 ppm, such as less than about 2 ppm (μg/g), such as less than about 1.5 ppm, such as less than about 1 ppm, such as less than about 0.8 ppm. In one aspect, the test can be run after molding the plaques (1 mm thickness) at a temperature of 185° C. and after the resin to produce the test plaque has been dried for two hours at 140° C. During the test, the plaques are extracted for 3 hr at 60° C. over water as specified by the testing procedure. Released formaldehyde can be measured 24 hours after extraction or 7 days after extraction.

When the polymer composition is dried for 2 hr. at 140° C. and molded at a temperature of 195° C., the test plaque having a thickness of 1 mm can display a formaldehyde emission pursuant to VDA 275 of less than about 15 ppm, such as less than about 10 ppm, such as such as less than about 5 ppm, such as such as less than about 3 ppm, such as such as less than about 2 ppm. When the polymer composition is dried for 2 hr. at 140° C. and molded at a temperature of 205° C., the test plaque having a thickness of 1 mm can display a formaldehyde emission pursuant to VDA 275 of less than about 20 ppm, such as less than about 15 ppm, such as less than about 10 ppm, such as less than about 5 ppm, such as less than about 4 ppm.

Another formaldehyde emission test is the 10-Liter Bag Test (using the VDA test plaque at 1 mm and at ca. 26 g). The 10-Liter Bag Test can be conducted on 26 g samples comprised of one or more plaques having a thickness of 1 mm and a total surface area (of one or more plaques) on one side of 100 mm×200 mm. Polymer compositions made according to the present disclosure can display a formaldehyde emission when tested according to the 10-Liter Bag Test of less than about 300 μg/m³, such as less than about 250 μg/m³, such as less than about 200 μg/m³, such as less than about 150 μg/m³. The 10-Liter Bag Test can be conducted on specimens molded at a temperature of 195° C.

The 10-Liter Bag Test can be conducted on specimens molded at a temperature of 205° C. and polymer compositions made according to the present disclosure can display a formaldehyde emission of less than about 10,000 μg/m³, such as less than about 5,000 μg/m³, such as less than about 1,000 μg/m³, such as less than about 750 μg/m³.

The formaldehyde stabilizer package of the present disclosure is particularly formulated to be combined with a polyoxymethylene polymer.

In general, any suitable polyoxymethylene polymer may be incorporated into the polymer composition.

The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. The polyoxymethylene polymer used in the polymer composition may comprise a homopolymer or a copolymer. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.01 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

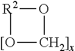

in which x is 0 or 1 and R² is a C₂-C₄-alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.01 to 5 mol. %, such as from 0.5 to 4 mol. %, of one of the above-mentioned comonomers. In one embodiment, the polyoxymethylene polymer contains relatively low amounts of comonomer. For instance, the comonomer can be present in an amount less than about 2 mol. %, such as less than about 1.5 mol. %, such as less than about 1 mol. %, such as less than about 0.8 mol. %, such as less than about 0.6 mol. %.

The polymerization can be effected as precipitation polymerization or in the melt. For example, the polyoxymethylene copolymer can be formed through solution hydrolysis in which a precipitate or powder is formed that has extremely low amounts of unstable end groups. By a suitable choice of the polymerization parameters, such as duration of polymerization or amount of molecular weight regulator, the molecular weight and hence the MVR value of the resulting polymer can be adjusted.

In one embodiment, the polyoxymethylene polymer used in the polymer composition may contain a relatively high amount of reactive groups or functional groups in the terminal positions. The reactive groups, for instance, may comprise —OH or —NH₂ groups.

In one embodiment, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 15 mmol/kg, such as at least 18 mmol/kg, such as at least 20 mmol/kg. In one embodiment, the terminal hydroxyl group content ranges from 18 to 50 mmol/kg. In an alternative embodiment, the polyoxymethylene polymer may contain terminal hydroxyl groups in an amount less than 20 mmol/kg, such as less than 18 mmol/kg, such as less than 15 mmol/kg. For instance, the polyoxymethylene polymer may contain terminal hydroxyl groups in an amount from about 5 mmol/kg to about 20 mmol/kg, such as from about 5 mmol/kg to about 15 mmol/kg. For example, a polyoxymethylene polymer may be used that has a lower terminal hydroxyl group content but has a higher melt volume flow rate.

In addition to or instead of the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O— repeat units.

In one embodiment, a polyoxymethylene polymer can be produced using a cationic polymerization process followed by solution hydrolysis to remove any unstable end groups. During cationic polymerization, a glycol, such as ethylene glycol or methylal can be used as a chain terminating agent. A heteropoly acid, triflic acid or a boron compound may be used as the catalyst.

The polyoxymethylene polymer can have any suitable molecular weight. The molecular weight of the polymer, for instance, can be from about 4,000 grams per mole to about 20,000 g/mol. In other embodiments, however, the molecular weight can be well above 20,000 g/mol, such as from about 20,000 g/mol to about 100,000 g/mol.

The polyoxymethylene polymer present in the composition can generally have a melt flow index (MFI) ranging from about 0.1 to about 80 cm³/10 min, as determined according to ISO 1133 at 190° C. and 2.16 kg. In one embodiment, the polyoxymethylene polymer may have a melt flow index of from about 5 cm³/10 min to about 15 cm³/10 min, such as from about 8 cm³/10 min to about 12 cm³/10 min. In an alternative embodiment, a polyoxymethylene polymer may be used that has a relatively high melt flow index. For instance, the polyoxymethylene polymer may have a melt flow index of from about 18 cm³/10 min to about 40 cm³/10 min, such as from about 20 cm³/10 min to about 35 cm³/10 min.

Suitable commercially available polyoxymethylene polymers are available under the trade name Hostaform® (HF) by Celanese.

The polyoxymethylene polymer may be present in the polyoxymethylene polymer composition in an amount of at least 50 wt. %, such as at least 60 wt. %, such as at least 70 wt. %, such as at least 80 wt. %, such as at least 85 wt. %, such as at least 90 wt. %, such as at least 93 wt. %. In general, the polyoxymethylene polymer is present in an amount of less than about 100 wt. %, such as less than about 99 wt. %, such as less than about 97 wt. %, wherein the weight is based on the total weight of the polyoxymethylene polymer composition.

The polymer composition of the present disclosure may also contain other known additives such as, for example, antioxidants, UV stabilizers or heat stabilizers, impact modifiers and/or reinforcing fibers. In addition, the compositions can contain processing auxiliaries, for example adhesion promoters, lubricants, nucleants, demolding agents, fillers, or antistatic agents and additives which impart a desired property to the compositions and articles or parts produced therefrom.

In one embodiment, an ultraviolet light stabilizer may be present. The ultraviolet light stabilizer may comprise a benzophenone, a benzotriazole, or a benzoate. The UV light absorber, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a nucleant may be present. The nucleant may increase crystallinity and may comprise an oxymethylene terpolymer. In one particular embodiment, for instance, the nucleant may comprise a terpolymer of butanediol diglycidyl ether, ethylene oxide, and trioxane. The nucleant may be present in the composition in an amount of at least about 0.01 wt. %, such as at least about 0.05 wt. %, such as at least about 0.1 wt. % and less than about 2 wt. %, such as less than about 1.5 wt. %, such as less than about 1 wt. %, wherein the weight is based on the total weight of the respective polymer composition.

In one embodiment, an antioxidant, such as a sterically hindered phenol, may be present. Examples which are available commercially, are pentaerythrityl tetrakis [3-(3,5-di-tert-butyl-4-hydroxyphenyl) propionate], triethylene glycol bis [3-(3-tert-butyl-4-hydroxy-5-methylphenyl) propionate], 3,3′-bis [3-(3,5-di-tert-butyl-4-hydroxyphenyl) propionohydrazide], and hexamethylene glycol bis [3-(3,5-di-tert-butyl-4-hydroxyphenyl) propionate]. The antioxidant may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lights stabilizers, such as sterically hindered amines, may be present in addition to the ultraviolet light stabilizer. Hindered amine light stabilizers that may be used include oligomeric hindered amine compounds that are N-methylated. For instance, hindered amine light stabilizer may comprise a high molecular weight hindered amine stabilizer. Other embodiments of light stabilizers include 2,2,6,6-tetramethyl-4-piperidyl compounds, e.g., bis(2,2,6,6-tetramethyl-4-piperidyl) sebacate or the polymer of dimethyl succinate and 1-(2-hydroxyethyl)-4-hydroxy-2,2,6,6-tetramethyl-4-piperidine. In one embodiment, the light stabilizer may comprise 2-(2H-benzzotriazol-2-yl) 4,6-bis(1-ethyl-1-phenyl-ethyl) phenol. The light stabilizers, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lubricants may be present. The lubricant may comprise a polymer wax composition. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. In another embodiment, a fatty acid amide such as ethylene bis (stearamide) may be present. Lubricants may generally be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a coloring agent may be present. Coloring agents that may be used include any desired inorganic pigments, such as titanium dioxide, ultramarine blue, cobalt blue, and other organic pigments and dyes, such as phthalocyanines, anthraquinnones, and the like. Other coloring agents include carbon black or various other polymer-soluble dyes. In one embodiment, a combination of coloring agents may be included in the polymer composition. For instance, the polymer composition may contain titanium dioxide in combination with carbon black. In an alternative embodiment, the coloring agents present in the polymer composition may comprise titanium dioxide in combination with at least one color pigment, such as a yellow pigment and a green pigment and optionally further in combination with carbon black. The coloring agent may be present in the composition in an amount of at least about 0.01 wt. %, such as at least about 0.05 wt. %, such as at least about 0.1 wt. %, such as at least about 0.5 wt. %, such as at least about 0.8 wt. %, such as at least about 1 wt. % and less than about 5 wt. %, such as less than about 2.5 wt. %, such as less than about 1 wt. %, wherein the weight is based on the total weight of the respective polymer composition.

Fillers that may be included in the composition include glass beads, wollastonite, loam, molybdenum disulfide or graphite, and/or inorganic or organic fibers.

Reinforcing fibers which may be included in the composition are mineral fibers, such as glass fibers, polymer fibers, in particular organic high-modulus fibers, such as aramid fibers, metal fibers, such as steel fibers, carbon fibers, natural fibers, and/or fibers from renewable resources.

These fibers may be in modified or unmodified form, e.g. provided with a sizing, or chemically treated, in order to improve adhesion to the polymer. Glass fibers are particularly preferred.

Glass fibers are provided with a sizing to protect the glass fiber, to smooth the fiber but also to improve the adhesion between the fiber and the matrix material. A sizing usually comprises silanes, film forming agents, lubricants, wetting agents, adhesive agents optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl) ethane-1,2-diamine, 3-(2-aminoethyl-amino) propyltrimethoxysilane, N-[3-(trimethoxysilyl) propyl]-1,2-ethane-diamine.

Film forming agents are for example polyvinylacetates, polyesters and polyurethanes. Sizings based on polyurethanes may be used advantageously.

The reinforcing fibers may be compounded into the polyoxymethylene matrix, for example in an extruder or kneader. However, the reinforcing fibers may also advantageously take the form of continuous-filament fibers sheathed or impregnated with the polyoxymethylene molding composition in a process suitable for this purpose, and then processed or wound up in the form of a continuous strand, or cut to a desired pellet length so that the fiber lengths and pellet lengths are identical. An example of a process particularly suitable for this purpose is the pultrusion process.

The reinforcing fibers can be present in the molding composition in an amount ranging from 5 to 45 wt.-%, such as from 10 to 40 wt.-%, wherein the weight is based on the total weight of the composition.

The polymer composition may further comprise an impact modifier such as a thermoplastic elastomer. Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE-E), thermoplastic polyamide elastomers (TPE-A) and in particular thermoplastic polyurethane elastomers (TPE-U).

In one particular embodiment, a thermoplastic polyurethane elastomer is used. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, poly(ethylene adipate)diol and poly(ε-caprolactone)diol; and polyether diols such as poly(tetramethylene ether)glycol, poly(propylene oxide)glycol, poly(ethylene oxide)glycol, polycarbonate diol and/or a polyester polycarbonate diol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

The amount of thermoplastic elastomer contained in the polymer composition can vary depending upon various factors. For instance, the thermoplastic elastomer can be present in an amount ranging from about 0.5% by weight to about 50% by weight. In one embodiment, for instance, a thermoplastic elastomer or impact modifier may be present in the composition in an amount less than about 25% by weight, such as in an amount less than about 15% by weight, such as in an amount less than about 10% by weight. The thermoplastic elastomer or impact modifier is generally present in an amount greater than about 2% by weight, such as in an amount greater than about 5% by weight, such as in an amount greater than about 8% by weight, such as in an amount greater than about 10% by weight.

In one embodiment, when an impact modifier or thermoplastic elastomer is present in the composition, the composition can also include a coupling agent. The coupling agent may comprise a polyisocyanate, such as a diisocyanate or triisocyanate. The coupling agent can be present generally in an amount from about 0.1% to about 2% by weight, such as from about 0.1% to about 1% by weight.

As described above, the composition can also be formulated so as not to contain various alkaline earth metal salts of aliphatic carboxylic acids. For example, in one embodiment, the polymer composition and molded articles made from the composition can be free from calcium stearate and/or calcium 12-hydroxystearate. Optionally, the polymer composition can also be free of other metal salts of carboxylic acids, such as calcium citrate including tricalcium citrate. In one aspect, however, minor amounts of a calcium citrate may be present, such as in amounts of from about 0.001% by weight to about 0.4% by weight.

The compositions of the present disclosure can be compounded and formed into a polymer article using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 100 to 280° C., such as from 120 to 260° C., such as from 140 to 240° C. or 180 to 220° C.

After extrusion, the compositions may be formed into pellets. The pellets can be molded into polymer articles by techniques known in the art such as injection molding, thermoforming, blow molding, rotational molding and the like.

The polymer composition of the present disclosure can be used to produce various molded parts. The parts can be formed through any suitable molding process, such as an injection molding process or through a blow molding process. Polymer articles that may be made in accordance with the present disclosure include knobs, door handles, automotive decorative trim pieces, and the like without limitation. Other polymer articles, for instance, that may be made in accordance with the present disclosure include latches, levers, gears, pivot housings, speaker grills, and the like.

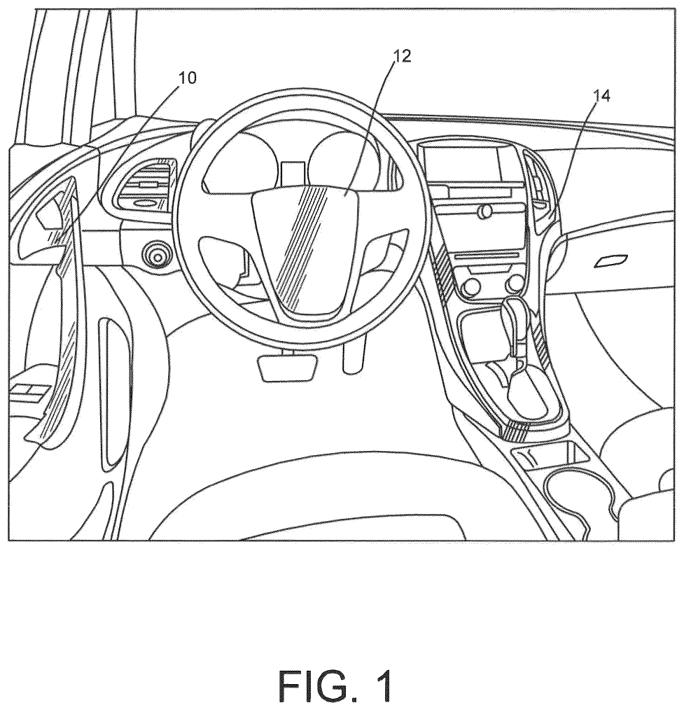

For instance, referring to FIG. 1, an automotive interior is shown illustrating various automotive parts that may be made in accordance with the present disclosure. The polymer composition, for instance, may be used to produce automotive part 10, which comprises at least a portion of an interior door handle. The polymer composition may also be used to produce a part on the steering column such as automotive part 12. In general, the polymer composition can be used to mold any suitable decorative trim piece or bezel, such as trim piece 14.

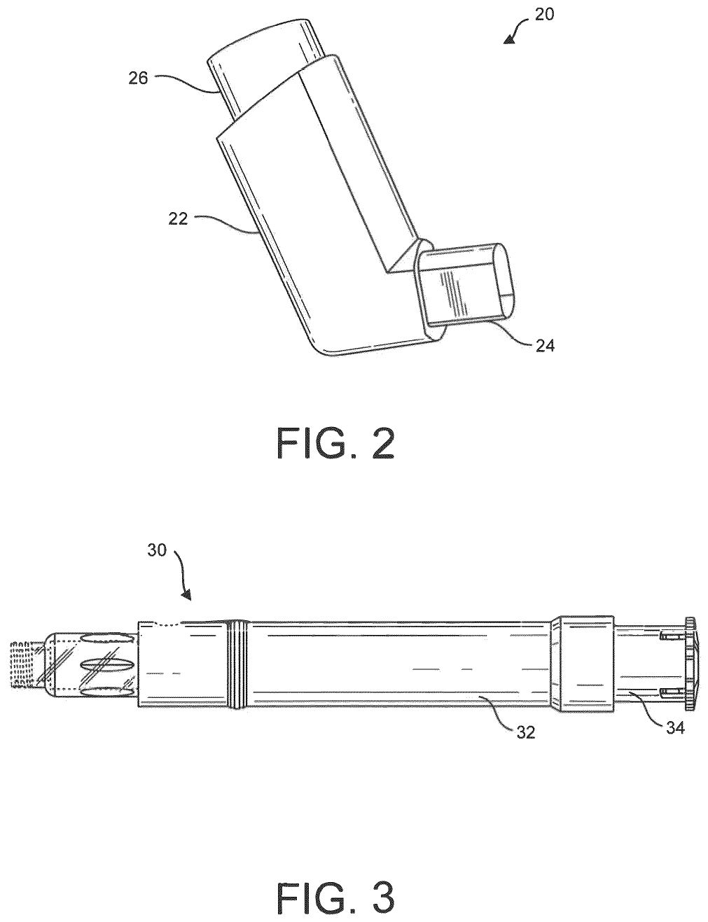

The compositions are also particularly well suited for use in producing medical products. For instance, referring to FIG. 2, an inhaler 20 is shown. The inhaler 20 includes a housing 22 attached to a mouthpiece 24. In operative association with the housing 22 is a plunger 26 for receiving a canister containing a composition to be inhaled. The composition may comprise a spray or a powder.

During use, the inhaler 20 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece. In accordance with the present disclosure, the housing 22, the mouthpiece 24 and the plunger 26 can all be made from a polymer composition as described above.

Referring to FIG. 3, another medical product that may be made in accordance with the present disclosure is shown. In FIG. 3, a medical injector 30 is illustrated. The medical injector 30 includes a housing 32 in operative association with a plunger 34. The housing 32 may slide relative to the plunger 34. The medical injector 30 may be spring loaded. The medical injector is for injecting a drug into a patient typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle. In accordance with the present disclosure, the housing 32 and/or the plunger 34 can be made from a polymer composition as described above.

While the polyoxymethylene polymer composition and polymer articles produced therefrom of the present disclosure provide improved emission properties, the compositions and articles may also exhibit excellent mechanical properties (ISO Test 527). For example, when tested according to ISO Test No. 527, the polymer composition may have a tensile modulus of greater than about 1,200 MPa, such as greater than about 2,000 MPa. The tensile modulus is generally less than about 10,000 MPa.

The polymer composition can exhibit a notched Charpy impact strength at 23° C. (ISO Test 179-1) of greater than about 3 KJ/m², such as greater than about 6 KJ/m². The notched Charpy impact strength is generally less than about 20 KJ/m².

The present disclosure may be better understood with reference to the following example.

### Example

The following example was conducted in order to demonstrate some of the advantages and benefits of polymer compositions made according to the present disclosure.

Various polymer compositions were formulated, molded into test specimens, and tested for formaldehyde emission. The polymer compositions contained a polyoxymethylene copolymer. The polyoxymethylene polymer had a melt volume rate of about 9 cm³/10 min according to ISO Test 1133. In addition to the polyoxymethylene polymer, the polymer composition contained 0.2% by weight of an antioxidant triethylene glycol bis(3-tert-butyl-4-hydroxy-5-methylphenyl) propionate and 0.2% by weight of ethylene bis(stearamide).

Various different additives were then combined with the above polymer composition and tested for formaldehyde emission. Each formulation was compounded on a 32 mm co-rotating twin-screw extruder (ZSK 32, Coperion, Germany). The test plaques were injection molded. The test plaques were molded at a temperature of 185° C., 195° C. and 205° C. from granules that were dried for two hours at 140° C. The test plaques had a thickness of 1 mm. As specified by the VDA test, the plaques were 40 mm×100 mm.

The samples were tested according to the Ford 10-Liter Bag Method (hereinafter “10-Liter Bag Method”), which is Test Reference No. BZ108-01 (Jul. 2, 2018), using the 1 mm test plaques having a total mass of about 26 g. Prior to testing, the plaques were conditioned for 72 hours at 23° C. and at 50% humidity as specified by the test.

The formulations were also tested for formaldehyde emission according to the VDA 275 Test using the 1 mm plaques. The plaques were stored for 24 hours at 23° C. and at 50% humidity. The plaques were then extracted as specified by the test for 3 hours at 60° C. over 50 mL E-water. Released formaldehyde was measured as specified by the test after 24 hours.

In addition to the ingredients described above, the polymer compositions tested also contained a formaldehyde stabilizer package. The formaldehyde stabilizer package contained a substituted hydantoin in combination with an aliphatic carboxylic hydrazide. The following table lists the components combined with the polyoxymethylene polymer, including the emission control agents, and the formaldehyde emission results. The results were also extrapolated to 7 days based on a plaque having a thickness of 2 mm.

| Sample No. | | 1 | 2 | 3 | 4 | 5 | 6 |
|---|---|---|---|---|---|---|---|
| Polyoxymethylene | | 0.25 | 0.25 | 0 | 0 | 0 | 0.25 |
| Terpolymer (nucleant) | | | | | | | |
| Tricalcium-Citrate | | 0.05 | 0.05 | 0.1 | 0 | 0 | 0 |
| Calcium-12-hydroxystearate | | 0 | 0 | 0 | 0.05 | 0.1 | 0 |
| Sebacic Acid Dihydrazide | | 0.05 | | | | | |
| 4-isopropyl-2,5- | | 0.05 | 0.1 | 0.05 | | | |
| dioxoimidazolidine-1,3- | | | | | | | |
| di(propionohydrazide) | | | | | | | |
| VDA275, | 185° C. (24 hours) | 1.2 | 0.9 | 1.0 | 10.3 | 22.2 | 0.7 |
| ppm | 185° C. (extrapolated | 0.2 | 0.2 | 0.2 | 2 | 4.2 | 0.1 |
| | to 7 days) | | | | | | |
| | 195° C. (24 hours) | 3.2 | 2.5 | 6.5 | 34.0 | 42.4 | 1.4 |
| | 195° C. (extrapolated | 0.6 | 0.5 | 1.2 | 6.5 | 8.1 | 0.3 |
| | to 7 days) | | | | | | |
| | 205° C. (24 hours) | 14.3 | 10.9 | 34.9 | 28.1 | 31.2 | 3.5 |
| | 205° C. (extrapolated | 2.7 | 2.1 | 6.6 | 5.3 | 5.9 | 0.7 |
| | to 7 days) | | | | | | |
| Tedlar | 185° C. | 91 | 88 | 97 | 15200 | 27200 | 91 |
| Bag test, | 195° C. | 993 | 325 | 6690 | NA | NA | 148 |
| μg/cm³ | 205° C. | 29000 | 21400 | 63700 | NA | NA | 556 |

As shown above, Sample No. 6 did not contain a calcium salt of a carboxylic acid and displayed unexpectedly lower formaldehyde emissions. Sample Nos. 4 and 5 containing a calcium stearate displayed elevated formaldehyde emissions, even at relatively low concentrations.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a polyoxymethylene polymer; and
a formaldehyde stabilizer package for reducing formaldehyde emissions, the formaldehyde stabilizer package comprising at least two emission control agents, the emission control agents comprising a combination of an aliphatic carboxylic hydrazide and a substituted hydantoin; and
wherein the polymer composition is free of calcium stearate and calcium 12-hydroxystearate.

2. A polymer composition as defined in claim 1, wherein the polymer composition is free of alkaline earth metal salts of an aliphatic carboxylic acid.

3. A polymer composition as defined in claim 1, wherein the aliphatic carboxylic hydrazide is present in relation to the substituted hydantoin at a weight ratio of from about 1:20 to about 10:1.

4. A polymer composition as defined in claim 1, wherein the substituted hydantoin contains two hydrazino carbonyl alkyl groups.

5. A polymer composition as defined in claim 1, wherein the substituted hydantoin comprises 4-isopropyl-2,5-dioxoimidazolidine-1,3-di(propionohydrazide).

6. A polymer composition as defined in claim 1, wherein the aliphatic carboxylic hydrazide comprises sebacic acid dihydrazide, dodecanedioic acid dihydrazide or mixtures thereof.

7. A polymer composition as defined in claim 1, wherein the aliphatic carboxylic hydrazide is present in the polymer composition in an amount less than about 0.15% by weight.

8. A polymer composition as defined in claim 1, wherein the polymer composition displays a formaldehyde emission when tested according to Test VDA-275 at a thickness of 1 mm, at a molding temperature of 205° C. of less than about 20 ppm.

9. A polymer composition as defined in claim 1, wherein the polymer composition displays a formaldehyde emission when tested according to Test VDA-275 at a thickness of 1 mm, at a molding temperature of 185° C. of less than about 8 ppm and displays a formaldehyde emission according to Test VDA-275 at a thickness of 1 mm at a molding temperature of 195° C. of less than about 15 ppm.

10. A polymer composition as defined in claim 1, wherein the polymer composition displays a formaldehyde emission when tested according to a 10-Liter Bag Test at a molding temperature of 195° C. of less than about 300 μg/m³.

11. A polymer composition as defined in claim 1, wherein the polymer composition displays a formaldehyde emission when tested according to a 10-Liter Bag Test at a molding temperature of 205° C. of less than about 10,000 μg/m³.

12. A polymer composition as defined in claim 1, wherein the substituted hydantoin is present in the polymer composition in an amount greater than about 0.01% by weight and in an amount less than about 0.5% by weight.

13. A polymer composition as defined in claim 1, wherein the polyoxymethylene polymer has a melt flow rate of from about 5 cm³ per 10 min to about 15 cm³ per 10 min when tested at 190° C. and at a load of 2.16 kg.

14. A polymer composition as defined in claim 1, wherein the polymer composition further contains a nucleant in an amount from about 0.05% by weight to about 1% by weight.

15. A polymer composition as defined in claim 1, wherein the polymer composition further contains a phenolic antioxidant in an amount from about 0.05% to about 2% by weight, and a lubricant in an amount from about 0.05% to about 1.5% by weight.

16. A polymer composition as defined in claim 1, wherein the polymer composition further contains a thermoplastic elastomer in an amount from about 5% to about 30% by weight.

17. A polymer composition as defined in claim 1, wherein the polymer composition further contains reinforcing fibers in an amount from about 3% by weight to about 40% by weight.

18. A polymer composition as defined in claim 1, wherein the polymer composition further contains a UV stabilizer.

19. A polymer composition comprising:
a polyoxymethylene polymer;
a formaldehyde stabilizer package for reducing formaldehyde emissions, the formaldehyde stabilizer package comprising a combination of an aliphatic carboxylic hydrazide and a substituted hydantoin, the substituted hydantoin containing two hydrazino carbonyl alkyl groups; and
a formaldehyde emission when tested according to Test VDA-275 at a thickness of 1 mm, at a molding temperature of 205° C. of less than about 20 ppm, and a formaldehyde emission when tested according to a 10-Liter Bag Test at a molding temperature of 205° C. of less than about 1000 μg/m³.

20. A polymer composition as defined in claim 19, wherein the polymer composition is free of alkaline earth metal salts of an aliphatic carboxylic acid.

21. A molded article made from a polymer composition of claim 1.

22. A molded article as defined in claim 21, wherein the molded article comprises an interior automotive part, a latch, a lever, a gear, a pivot housing, a speaker grill, a door handle, a decorative trim piece, a bracket, a seat rail, an inhaler, or an injector.
